(19) United States
(12) Patent Application Publication
(10) Pub. No.: US 2007/0129094 A1
(43) Pub. Date: Jun. 7, 2007

(54) Power control apparatus and method of time division duplex (TDD) telecommunication system

(76) Inventors: Su-Ryong Jeong, Suwon-si (KR); Young-Kwon Cho, Suwon-si (KR); Young-Bin Chang, Anyang-si (KR); Jung-Soo Woo, Suwon-si (KR); Deok-Ki Kim, Seongnam-si (KR); Jae-Hyuk Jang, Bukgu (KR); Dong-Seek Park, Yongin-si (KR); Joon-Young Choi, Suwon-si (KR); Hailin Jiang, Beijing (CN); Xufeng Zheng, Beijing (CN)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/635,072

(22) Filed: Dec. 7, 2006

(30) Foreign Application Priority Data
Dec. 7, 2005 (KR) 2005-0118762

(51) Int. Cl. H04B 7/00

(52) U.S. Cl. 455/522; 455/69

(57) ABSTRACT

Provided is a power control apparatus and method of a time division duplex (TDD) communication system. The power control apparatus includes an uplink power determiner for determining an uplink power value using a power control computation element of a current frame, which is acquired using a power control computation element of a prior frame and a power increase/decrease change estimated from a downlink, and a cell interference received from a base transceiver station (BTS); and an uplink power controller for controlling an uplink power by sending the uplink power value from the uplink power determiner to a transmitter.

### CROSS-REFERENCE TO RELATED APPLICATION

This application claims the benefit under 35 U.S.C. § 119(a) of an application filed in the Korean Intellectual Property Office on Dec. 7, 2005 and assigned Serial No. 2005-118762, the entire disclosure of which is hereby incorporated by reference.

### BACKGROUND OF THE INVENTION

1. Field of the Invention

The present invention relates generally to a power control method and apparatus of a Time Division Duplex (TDD) telecommunication system. More particularly, the present invention relates to a power control apparatus of a TDD telecommunication system, which includes an uplink power determiner which acquires a power control computation element of a current frame using a power control computation element of a prior frame and a power increase/decrease change and determines an uplink power value using the power control computation element, and an uplink power controller which controls an uplink power by sending the uplink power value from the uplink power determiner to a transmitter, and a power control method thereof.

2. Description of the Related Art

FIG. 1 depicts connections between components of a conventional wireless telecommunication system. The wireless telecommunication system includes a core network (CN) 101, a base station controller (BSC) 102, a base transceiver station (BTS) 103, and a mobile station (MS) 104. The CN 101 is responsible to manage terminal position, call connection, and so forth. The BSC 102 serves to control radio resources to be allocated to a BTS connected thereto. The BTS 103 performs data communications with the MS 104.

FIG. 2 depicts structures of uplink and downlink between a BTS and a MS in a Time Division Duplex (TDD)-Code Division Multiplexing (CDM)/Code Division Multiple Access (CDMA) communication system. In FIG. 2, the horizontal axis indicates a time domain and the vertical axis indicates a frequency domain. TDD, one of schemes which separate the uplink data transmission from the MS to the BTS and the downlink data transmission from the BTS to the MS, uses the same frequency band for the uplink and the downlink and separates the uplink and the downlink through time division. In more detail, since a time interval containing the uplink signal and a time interval containing the downlink signal are predefined, the uplink signal and the downlink signal are allowed to transmit only in their predefined time interval. Accordingly, in the communication between the BTS and the MS, a downlink frame 201 and an uplink frame 202 are repeated in an alternating manner. After the downlink, a time interval is allocated for the uplink. Between the downlink and the uplink, a transmission gap 204 resides with no signal. Since the uplink and the downlink share the same frequency band, the transmission gap 204 is provided to prevent interference between the uplink signal and the downlink signal. At a front portion of the downlink channel frame, there is a broadcast (common) channel 203 to transmit system information. Following the broadcast channel 203, traffic channels are divided by code area for the transmission of data to users. The uplink channel frame 202 is divided into code areas 205 and 206 assigned to respective users. Each MS receives downlink data from the BTS in the code area assigned to its traffic channel and transmits uplink data to the BTS.

Power control is utilized to keep a Signal to Interference Ratio (SIR) at a target value of the received signal by controlling the power consumed for the signal transmission between the MS and the BTS. The following explanation exemplifies the uplink to transmit signals from the MS to the BTS.

An open loop power control is used for the initial uplink in which signals are transmitted to the BTS upon the first power-on of the MS. Before the initial uplink generation, the BTS informs the MS of its transmit signal power using a message and the MS estimates path loss by measuring the received signal power and controls the power required for the signal transmission of the initial uplink by taking into account the path loss.

Open loop power is expressed in Equation 1.
P_{DPCH}=α·L_{PCCPCH}+(1−α)·L₀+I_{BTS}+SIR_{target}+DPCH_{const} [Equation 1]

In Equation 1, L_{PCCPCH} is the path loss of the downlink (PCCPCH). The transmit output value of the downlink P_{PCCPCH,tx} is informed to the MS through a message from the BTS. When acquiring the measured receive power of the downlink P_{PCCPCH,tx}, the MS acquires the path loss value L_{PCCPCH} based on L_{PCCPCH}=P_{PCCPCH,tx}−P_{PCCPCH,rx}. L₀ is a long time average value of the path loss. The path loss is defined as a weighted average of L_{PCCPCH} and L₀. That is, path loss=α·L_{PCCPCH}+(1−α)·L₀, where α is an arbitrary constant. I_{BTS} is an interference power measured by the BTS. The interference power information is provided to each MS by the BTS. SIR_{target} is a power needed to get a target value of the SIR that each terminal needs to obtain. SIR_{target} is informed using a message prior to a dedicated physical channel generation. When it is necessary to renew SIR_{target} after the dedicated physical channel generation, it is transmitted to the MS using a message. DPCH_{const} is a power compensation value for fine adjustment of the open loop power control in the operating area.

According to the open loop power control, the power control of the uplink signal after the initial uplink transmission is conducted under the direction of the BTS, and is a closed loop power control. More specifically, after calculating the SIR of the signal received from the MS, the BTS compares the SIR with a target SIR set for each MS. When the SIR is smaller than the target value, the BTS sends a power increase signal to the MS. When the SIR is greater than the target value, the BTS sends a power decrease signal. Thereby, the MS controls the transmit power accordingly.

FIG. 3 depicts an open loop power control process and a closed loop power control process for the uplink signal transmission of the TDD-CDM/CDMA communication system. First, the BST transmits the downlink (PCCPCH) to the MS (301). The MS then measures a power of a pilot signal of the downlink (PCCPCH) (302) and determines the system information (303). Prior to the call setup, a radio bearer setup 304 is carried out and the physical layer is initialized (305). Upon the completion of the call setup, the MS transmits a first uplink frame (306) with the calculated open loop power (307) (open loop power control). The BTS receives a frame, measures the SIR, compares the SIR with the target SIR, and feeds back a Transmit Power Control (TPC) command to the MS (308). The MS then transmits the next data frame by increasing or decreasing the power to some degree according to the TPC command (309) (closed loop power control).

Such a power control method enables several MSs to transmit and receive data to and from the BTS in the same transmit frequency band using different spreading codes. In doing so, the transmit channels of the MSs are distinguished by the spreading code. However, when there are several channels in the same transmit frequency band, when the transmit power of a specific channel is too high it acts as critical interference to other channels (users). Thus, the BTS must receive and control the signals of all of the channel users. In doing so, it is required to transmit power control information determined by the BTS for each user in a separate channel. Additionally, for rapid and accurate power control, the closed loop power control method needs to function in real time and correct for substantial change even when the call is being connected. To this end, large overhead is required. The conventional system merely enables power control such that the BS sends the fixed power change unit of a specific value to each MS at the initial call setup and then transmits the increase/decrease signal for the fixed power change unit while the call is connected. Therefore, even when the severe channel change happens all of a sudden, it is hard to control the power for the change.

The above power control method is feasible in case where one channel of the uplink is continuously occupied by a user over a certain time duration. FIG. 6 depicts that the open loop power control and the closed loop power control are feasible when a user occupies a channel of the uplink continuously over a time duration. In this case, the MS is able to achieve the closed loop power control by utilizing feedback information 608 and 609 for each channel.

Meanwhile, next-generation wireless telecommunication systems are being developed that enable the delivery of massive amounts of information within a short time period. As for a voice communication channel which does not require the continuous transmission of massive amounts of data, it is necessary for several user terminals to time-divide and occupy one channel. However, in this case according to the conventional method, the feedback information continuously received from the BTS in the downlink cannot be utilized for closed loop power control when transmitting the next uplink data of the corresponding user, and the transmit frame subject to the power control is not continuously transmitted in the same channel but is instead non-continuously transmitted in another channel according to the time. Thus, the transmit channel condition abruptly changes to a great extent during the time. That is, in such a case, closed loop power control is infeasible because the BTS cannot issue a power control command to each MS.

Therefore, for the non-continuous uplink channel where several users time-divide and occupy one channel such as voice communication channel requiring no continuous transmission of massive amounts of data, what is needed is a power control method and apparatus which enable the accurate power control value update without a separate feedback value.

In addition, what is needed is a power control apparatus and method which can apply a variable corresponding to a substantial channel change to the power control during the call connection.

### SUMMARY OF THE INVENTION

Exemplary embodiments of the present invention address at least the above problems and/or disadvantages and provide at least the advantages described below. Accordingly, an aspect of an exemplary embodiment of the present invention is to provide a power control apparatus and method enabling accurate power value control for the non-continuous uplink channel where one channel is time-divided and used by several users.

Another aspect of an exemplary embodiment of the present invention is to provide a power control apparatus and method which can control a power value corresponding to the channel change even when the call is being connected.

The above aspects are achieved by providing a power control apparatus of a time division duplex (TDD) communication system, which includes an uplink power determiner for determining an uplink power value using a power control computation element of a current frame, which is acquired using a power control computation element of a prior frame and a power increase/decrease change estimated from a downlink, and a cell interference received from a base transceiver station (BTS); and an uplink power controller for controlling an uplink power by sending the uplink power value from the uplink power determiner to a transmitter.

According to one aspect of an exemplary embodiment of the present invention, a power control method of a TDD communication system includes calculating a power control computation element of a current frame using a power control computation element of a prior frame and a power increase/decrease change estimated from a downlink, calculating an uplink power value using and a cell interference at a BTS and the power control computation element of the current frame; and controlling an uplink power by sending the uplink power value to a transmitter.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates connections between components of a conventional wireless telecommunication system;

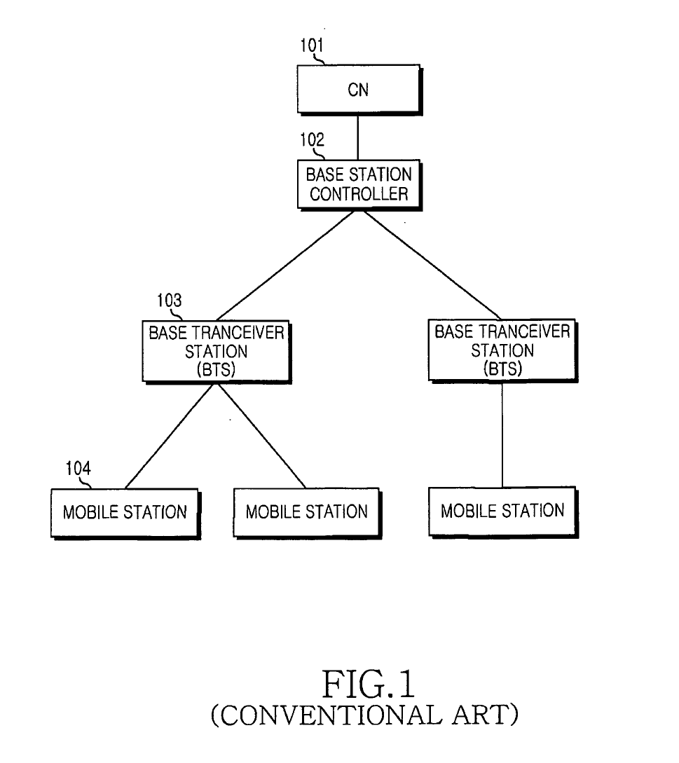

FIG. 2 illustrates uplink and downlink frames between a BTS and a MS in a conventional TDD-CDM/CDMA communication system;

FIG. 3 illustrates an open loop power control method and a closed loop power control method for an uplink signal transmission of the conventional TDD-CDM/CDMA communication system;

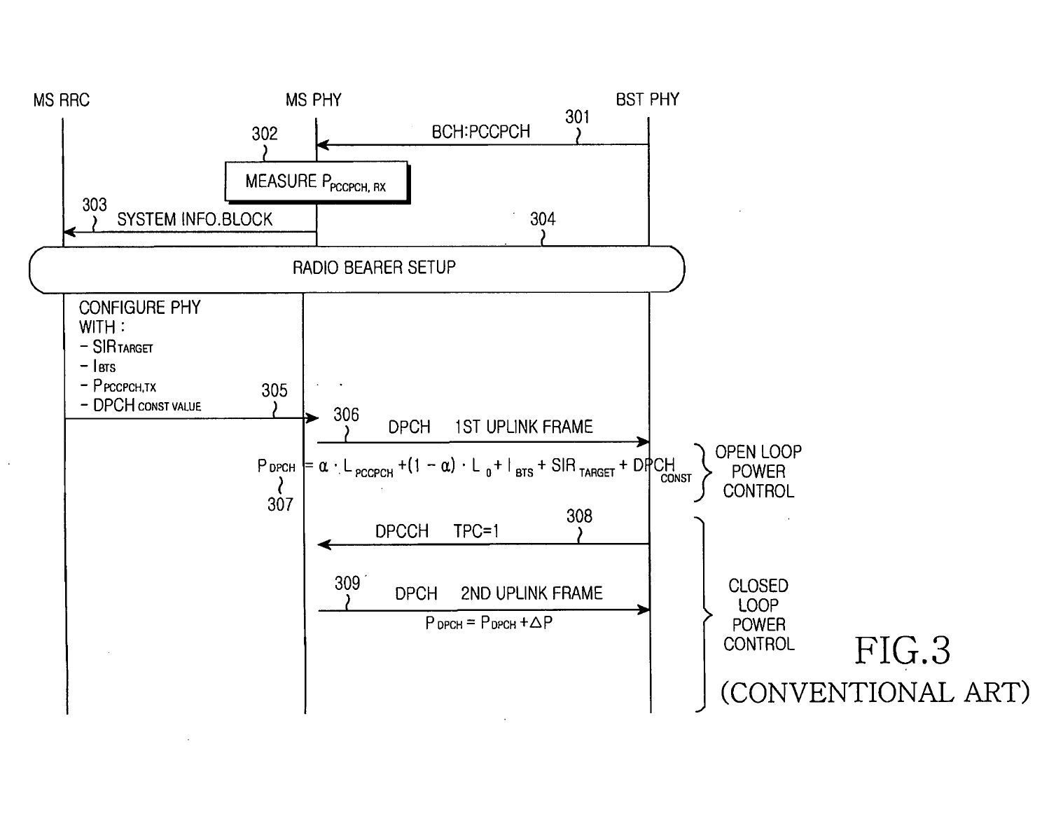

FIG. 4 illustrates construction of a downlink frame and an uplink frame in a TDD-OFDM communication system according to an exemplary embodiment of the present invention;

FIG. 5 illustrates construction of a downlink frame and an uplink frame in a TDD-OFDMA communication system according to an exemplary embodiment of the present invention;

FIG. 6 illustrates the open loop power control and the closed loop power control when a user continuously uses a channel of the uplink over a time duration in the related art;

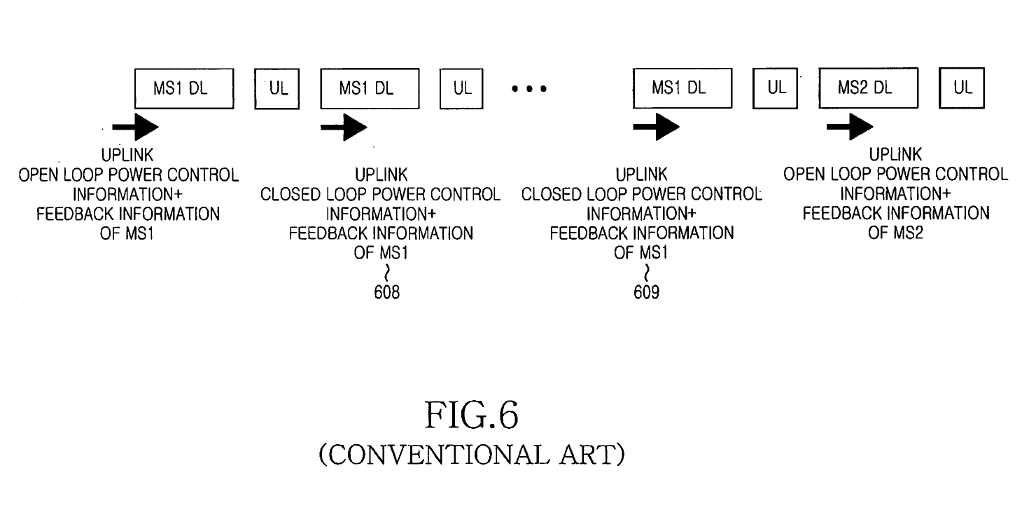

FIG. 7 illustrates the open loop power control when users share a channel of the uplink;

FIG. 8 illustrates construction of uplink and downlink between a BTS and a MS in a TDD-OFDM/OFDMA system according to an exemplary embodiment of the present invention;

FIG. 9 illustrates a power control process in the transmission and reception between the BTS and the MS in the communication system according to an exemplary embodiment of the present invention;

FIG. 10 is a flowchart outlining the power control process at the MS according to an exemplary embodiment of the present invention; and

FIG. 11 is a block diagram of the MS which implements the power control method according to an exemplary embodiment of the present invention.

Throughout the drawings, the same drawing reference numerals will be understood to refer to the same elements, features, and structures.

### DETAILED DESCRIPTION OF PREFERRED EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. The exemplary embodiment of the present invention exemplifies a Time Division Duplexing Orthogonal Frequency Division Multiplexing (TDD-OFDM) communication system or a TDD Orthogonal Frequency Division Multiple Access (OFDMA) communication system. Such communication systems completely separate the frequencies between the channels. Also, those communication systems accomplish the voice signal transmission, in which it is rare to transmit mass data continuously through one channel, by means of a non-continuous uplink channel which is time-divided and occupied by several users.

The OFDM or OFDMA scheme transmits serial modulation symbols as parallel data. Examples of the OFDM or OFDMA scheme include a 802.16 WirelessMAN-OFDM system and a WirelessMAN-OFDMA system.

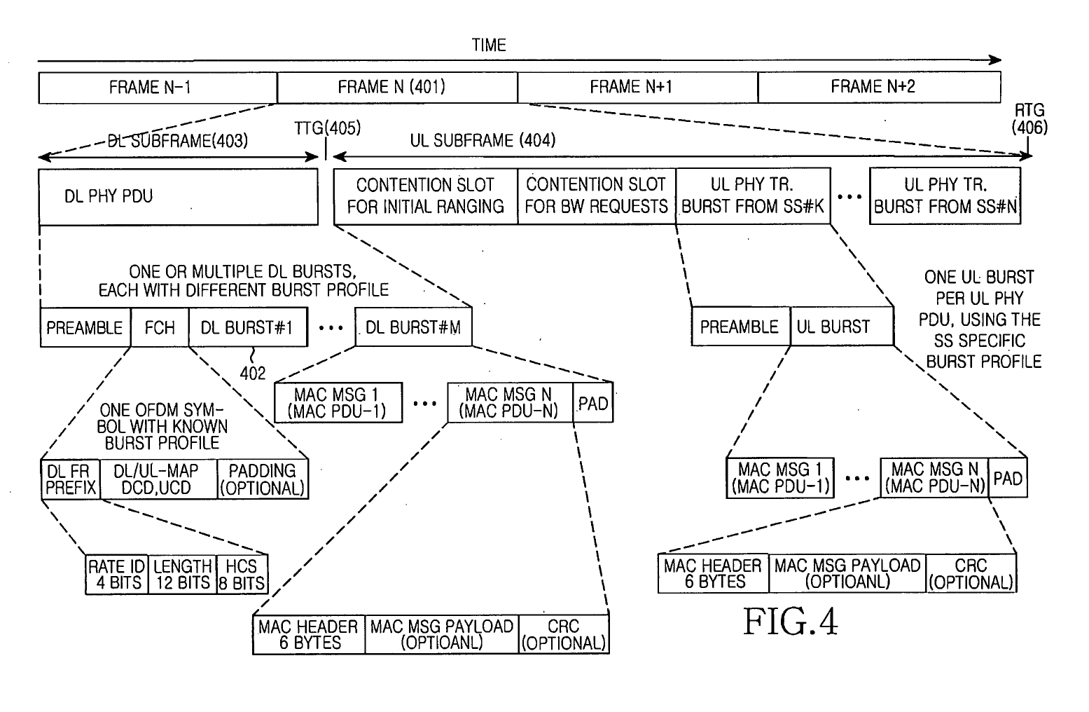

FIG. 4 illustrates construction of a downlink frame and an uplink frame in a TDD-OFDM communication system according to an exemplary embodiment of the present invention. Each frame (401) consists of bursts (402) defined in quadrangles in a time plane. The downlink subframe (403) and the uplink subframe (404) are duplexed according to the TDD scheme. Time intervals called TTG (405) and RTG (406) are placed between the downlink subframe and the uplink subframe. The 802.16 WirelessMAN-OFDM system constructs one OFDM symbol with 2048 modulation symbols. A subchannel formed from subcarriers constituting one OFDM symbol and a plurality of OFDM symbols constitutes one frame.

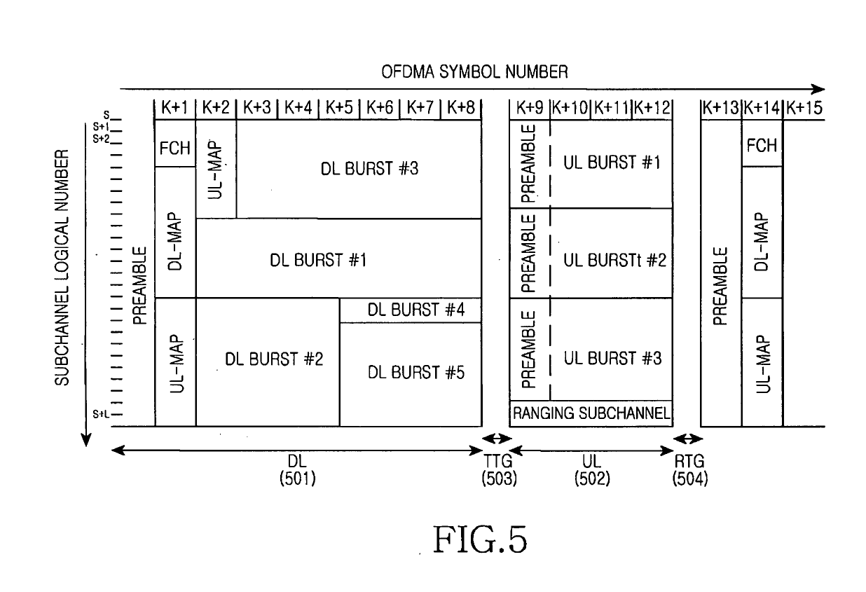

FIG. 5 illustrates the construction of a downlink frame and an uplink frame in a TDD-OFDMA communication system according to an exemplary embodiment of the present invention. Each frame consists of bursts defined in quadrangles in a time-frequency plane. The downlink frame (501) and the uplink frame (502) are duplexed according to the TDD scheme, and time intervals called TTG (503) and RTG (504) are placed between the downlink frame (501) and the uplink frame (502). In the 802.16 WirelessMAN-OFDMA system, each MS compensates time error and frequency error of each burst of the uplink frame and performs the ranging for the power adjustment. When a MS attempts the ranging, a BTS measures a signal power of the MS and transmits to the MS a signal power loss compensation value due to the path loss and the abrupt change of the signal power using a MAC message.

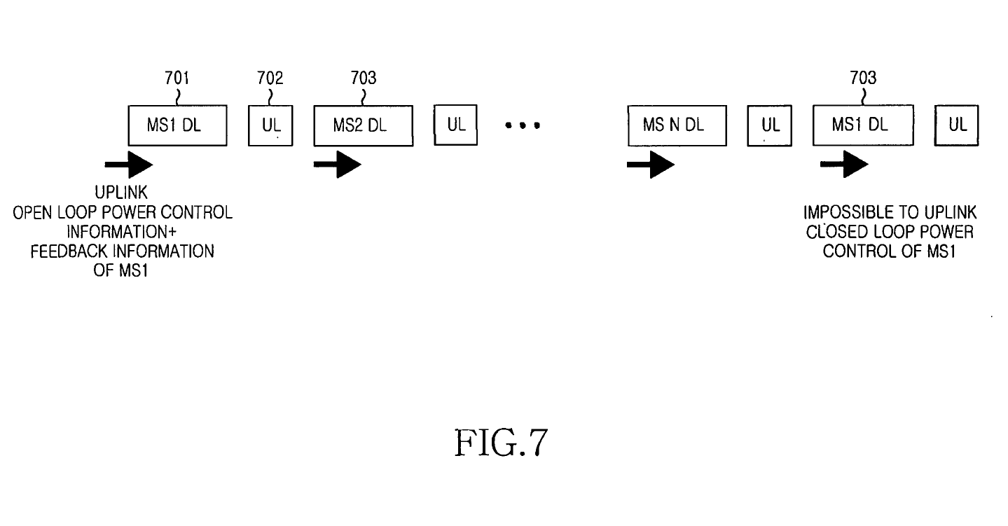

FIG. 7 illustrates the open loop power control when users share a channel of the uplink. The BTS cannot use the receive power of the MS1 through the uplink 702 after the power control to the MS1 701 as power control information for a MS2 in the downlink 703 of the next frame. This is true for the MS1 703 that follows. As such, when the users share the one channel of the uplink, that is, when a user does not continuously occupy the one channel over a time duration, the closed loop power control is infeasible because the BTS does not know from which MS (user) the signal is transmitted, and thus only the open loop power control is possible. As discussed previously, next-generation wireless telecommunication systems are able to deliver large amounts of information within a short time. It comes under the case where one user does not continuously occupy one channel over a time duration since it is necessary to time-divide and occupy one channel for multiple users in case of the voice communication channel not requiring the continuous transmission of the large amount of data.

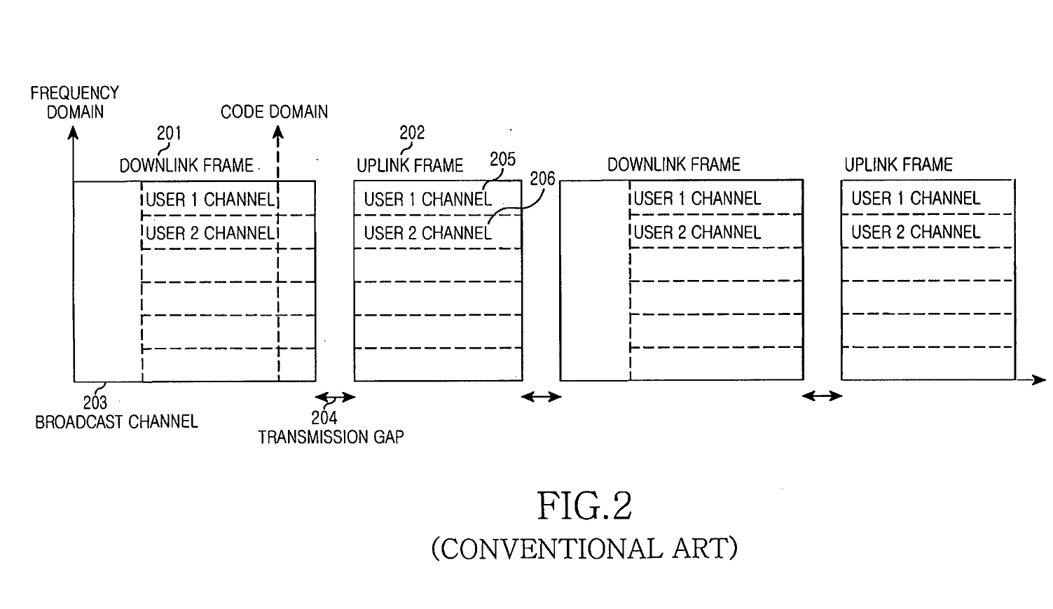

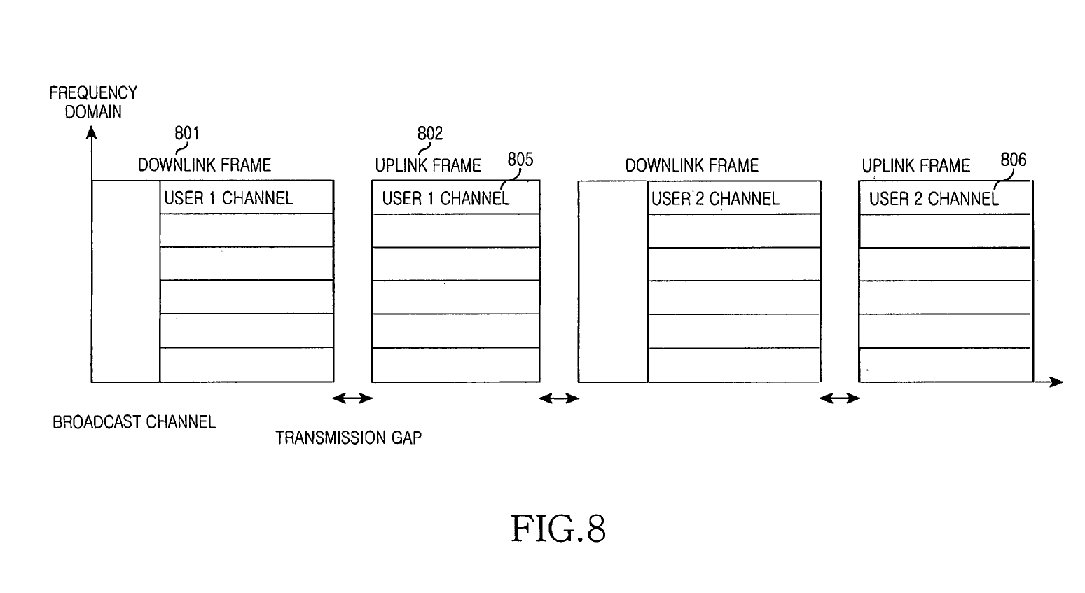

FIG. 8 illustrates the construction of an uplink 802 and a downlink 801 between a BTS and a MS in a TDD-OFDM/OFDMA system according to an exemplary embodiment of the present invention. As shown in FIG. 8, in the TDD-OFDM/OFDMA system, the channels are completely separated by the frequency band, unlike the link frame as shown in FIG. 2. Also, the uplink channel does not suffer from interference between the channels because only one user (805 in the first time and 806 in the second time) occupies within one time slot. Therefore, power control information taking account of the other channels is unnecessary.

Descriptions are provided on the power control method of the non-continuous uplink channel when there is no need to continuously transmit the mass data (e.g., the voice communication) and several users share one channel being time-divided in the TDD-OFDM or the TDD-OFDMA communication system where frequencies between the channels are completed separated. Note that exemplary embodiments of the present invention are applicable to a TDD-Frequency Division Multiplexing (FDM) or TDD-Frequency Division Multiple Access (FDMA) communication system.

Acquiring the path loss, the channel effect, and the interference, the user (the MS) can estimate the receive power of the BTS with respect to a signal to transmit. Since the TDD system shares the transmission and reception band according to its characteristic, it can be said that the uplink and the downlink suffer the same path loss and channel effect. On this assumption, each user can estimate the power control information of the uplink, excluding the cell interference power, by analyzing the power of the downlink received from the BTS.

It is possible to utilize the power of the preamble or the pilot in the downlink from the BTS to the MS and the average signal power of the corresponding band as elements for estimating the path loss and the channel effect in relation to the uplink. Particularly, since those elements are the power information that can be measured and utilized by the other MSs not currently using the corresponding channel, it is possible to support the MS discontinuously using the corresponding band. Thus, those elements are suited well for the characteristic of the communication system which sends the non-continuous data bursts.

Yet, each MS can not be aware of the interference suffered by the BTS during the reception. Hence, the BTS needs to transmit the power of the cell interference to every user in a separate channel. However, this information is also commonly applied to every user who uses the corresponding channel band in the cell. Accordingly, all MSs can commonly utilize the information by periodically sending the information in a broadcast channel.

The conventional system takes account of the cell interference power (I_{BTS}) of the BTS merely in the open loop power control at the uplink commencement. By contrast, an exemplary embodiment of the present invention transmits the information periodically or at an unspecific time if necessary so as to support the accurate power control at the MS based on the information.

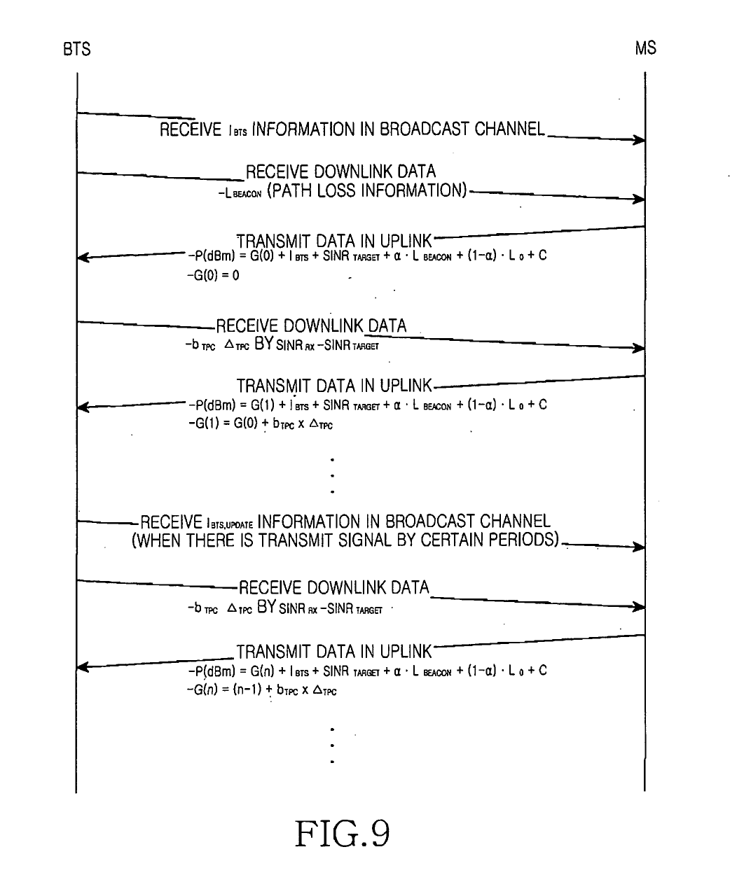

FIG. 9 illustrates a power control process in the transmission and reception between the BTS and the MS in the communication system according to an exemplary embodiment of the present invention. Initially, the path loss (L_{Beacon}) which is path loss information when generating a call, is estimated by measuring the elements such as average powers of data in the preamble, the pilot and the other corresponding bands of the downlink as shown in FIG. 9. Separately, the cell interference power (I_{BTS}) at the BTS is received from the BTS and applied to a power control equation.

Afterwards, the transmit power information is continuously maintained based on the difference between the receive-SIR and the target-SINR at a periodic time or at an unspecified time by analyzing the downlink in the same manner. Meanwhile, when receiving a cell interference power (I_{BTS}) of the BTS with respect to another periodic time or at an unspecified time from the BTS, the MS updates the existing cell interference power and thereby controls the power. The controlled power is expressed as Equation 2.
P(dBm)=G(n)+I_{BTS}+P(SINR_{TARGET})+α·L_{Beacon}+(1−α)·L₀30 C(dBm) [Equation 2]

In Equation 2, P(dBm) denotes an uplink control power value, G(n) denotes a power control computation element of the current frame, I_{BTS} denotes the cell interference power at the BTS, P(SINR_{TARGET}) denotes a power corresponding to the target-SINR, L_{Beacon} denotes the current path loss acquired using the preamble, the pilot, and so forth of the current downlink frame, L₀ denotes an average path loss observed for a long term, α is an arbitrary constant, and C is a constant relating to the power of the transmit data.

In Equation 2, α·L_{Beacon}+(1−α)·L₀ represents the path loss and α is an arbitrary constant for combining two elements. I_{BTS} is the cell interference power at the BTS and mostly is the interference power at the BTS due to signals of the corresponding band users outside the cell. It can be assumed that different MSs sharing the same band in a relevant cell have the identical value. Accordingly, when the BTS transmits the interference power by periods or at a specific time through the broadcast (common) channel, every MS can utilize it.

The power control computation element G(n) is defined as Equation 3.
G(n)=G(n−1)+[b_{TPC}×Δ_{TPC}] [Equation 3]

In Equation 3, n denotes an index according to the power control cycle, G(n) denotes a power control computation element of the current frame, G(n−1) denotes a power control element of the prior frame, b_{TPC} denotes a variable indicating the power increase or the power decrease, and Δ_{TPC} denotes a change value, which varies when the power increases or decreases. b_{TPC}×Δ_{TPC} represents the power increase/decrease change.

Δ_{TPC}, which is the value corresponding to the transmit power change according to the substantial channel condition, enables the more rapid and accurate power control for the non-continuous bursts or the abrupt channel change. Also, since it is possible to estimate Δ_{TPC} based on the downlink, a separate feedback value is unnecessary. Particularly, according to an exemplary embodiment of the present invention, the corresponding variable is subdivided to correspond to several steps as defined in Equation 4 so as to raise the accuracy of the power control and to correspond to the substantial channel change. Additionally, without a separate feedback value, it is possible to actively adjust the power control change while the call is connected.

$$\begin{matrix}{b}_{TPC} = \{ \begin{matrix}+ 1 , SINR < {SINR}_{Target} \\ - 1 , SINR \geq {SINR}_{Target}\end{matrix} \\ {Δ}_{TPC} = \{ \begin{matrix}1 , \vert {P}_{( n )} - {P}_{( n - 1 )} \vert < {TH}_{1} \\ 2 , {TH}_{1} \leq \vert {P}_{( n )} - {P}_{( n - 1 )} \vert \leq {TH}_{2} \\ 3 , \vert {P}_{( n )} - {P}_{( n - 1 )} \vert > {TH}_{2}\end{matrix} \\ or \\ {Δ}_{TPC} = \{ \begin{matrix}1 , \vert SINR - {SINR}_{Target} \vert < {TH}_{1} \\ 2 , {TH}_{1} \leq \vert SINR - {SINR}_{Target} \vert \leq {TH}_{2} \\ 3 , \vert SINR - {SINR}_{Target} \vert > {TH}_{2}\end{matrix}\end{matrix} \qquad [ Equation 4 ]$$

In Equation 4, P₍ₙ₎ denotes the receive power value of the downlink of the current frame, P₍ₙ₋₁₎ denotes the receive power value of the downlink of the prior frame, SINR_{Target} denotes the target-SINR, SINR denotes the receive SINR value, and TH s denote preset thresholds.

In Equation 4, provided that the BTS transmits the downlink with a uniform power value, Δ_{TPC} can take the difference between the power (P₍ₙ₋₋₁)) measured with the previous receive signal and the power (P₍ₙ₎) measured with the current receive signal, or the difference between the target SINR and the SINR estimated with the current receive signal. At this time, it is assumed that the target SINR is a preset constant already known to both the MS and the BTS.

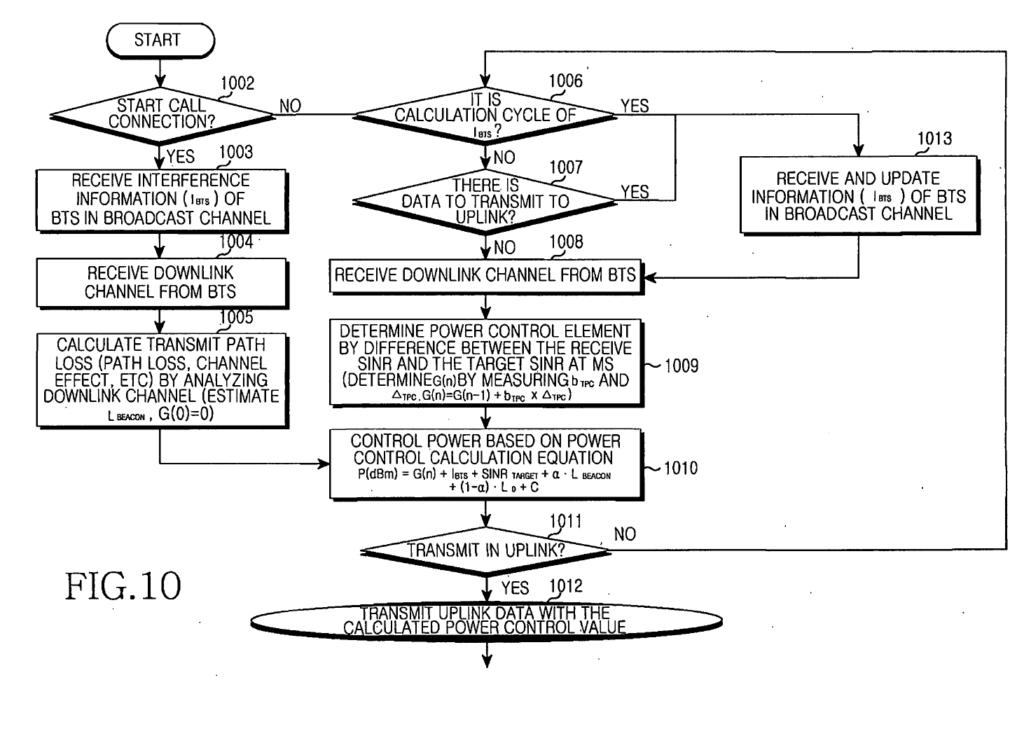

FIG. 10 is a flowchart outlining the power control process at the MS according to an exemplary embodiment of the present invention. As shown in FIG. 10, when the initial call is connected at step 1002, since there is no information relating to the power change of the prior frame, that is, no power control element of the prior frame (G(n−1)), the MS receives the cell interference power (I_{BTS}) from the BTS in the broadcast (common) channel at step 1003. Next, by receiving the downlink channel at step 1004, the MS calculates the path loss value at step 1005. At step 1010, the MS calculates the transmit path loss based on the aforementioned information in accordance with Equation 2.

However, if in step 1002 it is determined that the call is not an initial call, the process proceeds to step 1006. When it is a regular receive cycle for the cell interference power information at step 1006 or when there is data to transmit in the uplink at step 1007, the MS updates the cell interference information (I_{BTS}) of the BTS through the broadcast channel at step 1013. In the mean time, the MS receives a signal from the BTS in the downlink at step 1008, acquires the power control element G(n) of Equation 3 at step 1009, and then proceeds to step 1010 to carry out the power control. After the power control, according to whether there is uplink data or not at step 1011, the MS transmits the uplink data with the calculated power control value at step 1012 or returns to steep 1006.

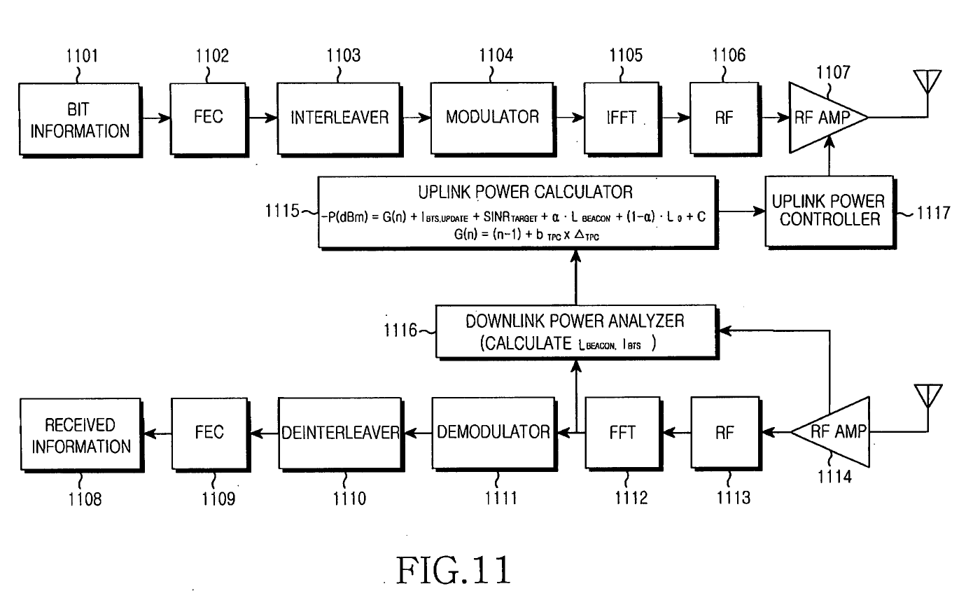

FIG. 11 is a block diagram of the MS which implements the power control method according to an exemplary embodiment of the present invention. In FIG. 11, a bit generator 1101, a FEC 1102, an interleaver 1103, a modulator 1104, an IFFT 1105, an RF stage 1106, and a transmit RF amplifier 1107 constitute a transmitter. A receive RF amplifier 1114, an RF stage 1113, a FFT 1112, a demodulator 1111, a deinterleaver 1110, a FEC 1109, and a received information block 1108 constitute a receiver. The components of the transmitter and the receiver are those of the conventional OFDM and OFDMA system.

In this system, a downlink power analyzer 1116 is provided to acquire the current path loss L_{Beacon} and the cell interference power I_{BTS} at the BTS by receiving the signal from the receiver. More specifically, the downlink power analyzer 1116 receives a signal from the receive RF amplifier 1114 and the FFT 1112 and uses the preamble and the pilot of the downlink frame.

The downlink power analyzer 1116 provides the calculated value to an uplink power calculator 1115. The uplink power calculator 1115 calculates the uplink transmit power using the provided value. Note that the downlink power analyzer 1116 and the uplink power calculator 1115 can be configured as a one block. In this case, this block is referred to as an uplink power determiner. The calculated uplink power value is applied to an uplink power controller 1117. The uplink power controller 1117 controls the uplink power by controlling the transmitter. More specifically the uplink power controller 1117 controls the transmit RF amplifier 1107. That is, the MS analyzes the downlink power and controls the uplink power using the cell interference power (I_{BTS}) received in the broadcast channel.

Exemplary embodiments of the present invention are applicable to not only the TDD-OFDM and TDD-OFDMA communication systems but also TDD-Frequency Division Multiplexing (FDM) and TDD-Frequency Division Multiple Access (FDMA) communication systems.

For the non-continuous uplink channel time-divided and occupied by the multiple users such as voice communication (e.g., VoIP) which does not require the continuous transmission of the massive amounts of data in one channel, exemplary embodiments of the present invention suggest a power control method with increased performance without a separate feedback value, as compared to the conventional closed loop power control method. Accordingly, exemplary embodiments of the present invention can support the non-continuous uplink user who has not been supported in the conventional system, and control the power according to the power increase/decrease change while the call is connected. Therefore, the power control algorithm can be improved and the transmission efficiency can be enhanced while being well suited for the characteristic of next-generation telecommunication systems.

While certain exemplary embodiments of the invention have been shown and described herein with reference to a certain preferred embodiments thereof, it will be understood by those skilled in the art that various changes in form and details may be made therein without departing from the spirit and scope of the invention as defined by the appended claims and their equivalents.

What is claimed is:

1. A power control apparatus of a time division duplex (TDD) communication system, comprising:
a power determiner for determining an uplink power value using a power control computation element of a current frame, which is acquired using a power control computation element of a prior frame and a power increase/decrease change estimated from a downlink, and a cell interference received from a base transceiver station (BTS); and
an uplink power controller for controlling an uplink power by sending the uplink power value from the uplink power determiner to a transmitter.

2. The power control apparatus of claim 1, wherein a power control computation element initial value of an initial frame is zero.

3. The power control apparatus of claim 1, wherein the power increase/decrease change indicates a difference between a power value of a signal received at a mobile station (MS) and a target power value of the MS.

4. The power control apparatus of claim 1, wherein the determining of the uplink power value or the uplink power control is conducted even when a call is connected between the BTS and the MS.

5. The power control apparatus of claim 1, wherein the uplink power value is calculated based on the equation:
$$\begin{matrix}P ( dBm ) = G ( n ) + {I}_{BTS} + P ( {SINR}_{TARGET} ) + α \cdot {L}_{Beacon} + ( 1 - α ) \cdot {L}_{0} + C ( dBm ) \\ G ( n ) = G ( n - 1 ) + [ {b}_{TPC} \times {Δ}_{TPC} ] \\ {b}_{TPC} = \{ \begin{matrix}+ 1 , SINR < {SINR}_{Target} \\ - 1 , SINR \geq {SINR}_{Target}\end{matrix} \\ {Δ}_{TPC} = \{ \begin{matrix}1 , \vert {P}_{( n )} - {P}_{( n - 1 )} \vert < {TH}_{1} \\ 2 , {TH}_{1} \leq \vert {P}_{( n )} - {P}_{( n - 1 )} \vert \leq {TH}_{2} \\ 3 , \vert {P}_{( n )} - {P}_{( n - 1 )} \vert > {TH}_{2}\end{matrix}\end{matrix}$$
where P(dBm) denotes an uplink control power value, G(n) denotes a power control computation element of the current frame, G(n−1) denotes a power control element of the prior frame, I_{BTS} denotes cell interference power at the BTS, P(SINR_{TARGET}) denotes a power corresponding to a target-signal to interference and noise ratio (SINR), L_{Beacon}, denotes current path loss acquired using a preamble and a pilot of a current downlink frame, L₀ denotes an average path loss observed for a long term, α is an arbitrary constant, C is a constant relating to a power of transmit data, P₍ₙ₎ denotes a receive power value of the downlink of the current frame, P₍ₙ₋1) denotes a receive power value of the downlink of the prior frame, SINR_{Target} denotes target-SINR, SINR denotes a receive SINR value, and TH s denote preset thresholds.

6. The power control apparatus of claim 1, wherein the uplink power value is calculated based on the equation:
$$\begin{matrix}P ( dBm ) = G ( n ) + {I}_{BTS} + P ( {SINR}_{TARGET} ) + α \cdot {L}_{Beacon} + \\ ( 1 - α ) \cdot {L}_{0} + C ( dBm ) \\ G ( n ) = G ( n - 1 ) + [ {b}_{TPC} \times {Δ}_{TPC} ] \\ {b}_{TPC} = \{ \begin{matrix}+ 1 , SINR < {SINR}_{Target} \\ - 1 , SINR \geq {SINR}_{Target}\end{matrix} \\ {Δ}_{TPC} = \{ \begin{matrix}1 , \vert SINR - {SINR}_{Target} \vert < {TH}_{1} \\ 2 , {TH}_{1} \leq \vert SINR - {SINR}_{Target} \vert \leq {TH}_{2} \\ 3 , \vert SINR - {SINR}_{Target} \vert > {TH}_{2}\end{matrix}\end{matrix} \qquad [ Equation 6 ]$$
where P(dBm) denotes an uplink control power value, G(n) denotes a power control computation element of the current frame, G(n−1) denotes a power control element of the prior frame, I_{BTS} denotes cell interference power at the BTS, P(SINR_{TARGET}) denotes a power corresponding to a target- SINR, L_{Beacon} denotes current path loss acquired using a preamble and a pilot of a current downlink frame, L₀ denotes an average path loss observed for a long term, α is an arbitrary constant, C is a constant relating to a power of transmit data, SINR_{Target} denotes target-SINR, SINR denotes receive SINR value, and TH s denote preset thresholds.

7. The power control apparatus of claim 5, wherein the I_{BTS} is received from the BTS in a broadcast channel periodically or at a specific time.

8. The power control apparatus of claim 6, wherein the I_{BTS} is received from the BTS in a broadcast channel periodically or at a specific time.

9. The power control apparatus of claim 1, wherein the uplink power determiner comprises:
a downlink power analyzer for acquiring the path loss of the downlink and the interference at the BTS; and
an uplink power calculator for calculating an uplink power value using the path loss and the interference provided from the downlink power analyzer.

10. The power control apparatus of claim 1, wherein the communication system is an orthogonal frequency division multiplexing (OFDM) or orthogonal frequency division multiple access (OFDMA) communication system.

11. The power control apparatus of claim 1, wherein the communication system is a frequency division multiplexing (FDM) or frequency division multiple access (FDMA) communication system.

12. The power control apparatus of claim 1, wherein the communication system uses a non-continuous link channel which is time-divided and occupied by a plurality of users.

13. A power control method of a TDD communication system, comprising:
calculating a power control computation element of a current frame using a power control computation element of a prior frame and a power increase/decrease change estimated from a downlink;
calculating an uplink power value using a cell interference at a BTS and the power control computation element of the current frame; and
controlling an uplink power by sending the uplink power value to a transmitter.

14. The power control method of claim 13, wherein a power control computation element initial value of an initial frame is zero.

15. The power control method of claim 13, wherein the power increase/decrease change indicates a difference between a power value of a receive signal received at a MS and a target power value of the MS.

16. The power control method of claim 13, wherein the calculating the uplink power value or the controlling the uplink power value is conducted even when a call is connected between the BTS and the MS.

17. The power control method of claim 13, wherein the uplink power value is calculated based on the equation:
$$\begin{matrix}P ( dBm ) = G ( n ) + {I}_{BTS} + P ( {SINR}_{TARGET} ) + α \cdot {L}_{Beacon} + ( 1 - α ) \cdot {L}_{0} + C ( dBm ) \\ G ( n ) = G ( n - 1 ) + [ {b}_{TPC} \times {Δ}_{TPC} ] \\ {b}_{TPC} = \{ \begin{matrix}+ 1 , SINR < {SINR}_{Target} \\ - 1 , SINR \geq {SINR}_{Target}\end{matrix} \\ {Δ}_{TPC} = \{ \begin{matrix}1 , \vert {P}_{( n )} - {P}_{( n - 1 )} \vert < {TH}_{1} \\ 2 , {TH}_{1} \leq \vert {P}_{( n )} - {P}_{( n - 1 )} \vert \leq {TH}_{2} \\ 3 , \vert {P}_{( n )} - {P}_{( n - 1 )} \vert > {TH}_{2}\end{matrix}\end{matrix}$$
where P(dBm) denotes an uplink control power value, G(n) denotes a power control computation element of the current frame, G(n−1) denotes a power control element of the prior frame, I_{BTS} denotes cell interference power at the BTS, P(SINR_{TARGET}) denotes a power corresponding to a target- SINR, L_{Beacon} denotes current path loss acquired using a preamble and a pilot of a current downlink frame, L₀ denotes an average path loss observed for a long term, α is an arbitrary constant, C is a constant relating to a power of transmit data, P₍ₙ₎ denotes a receive power value of the downlink of the current frame, P₍ₙ₋₁₎ denotes a receive power value of the downlink of the prior frame, SINR_{Target} denotes target-SINR, SINR denotes a receive SINR value, and TH s denote preset thresholds.

18. The power control method of claim 13, wherein the uplink power value is calculated based on the equation:
$$\begin{matrix}P ( dBm ) = G ( n ) + {I}_{BTS} + P ( {SINR}_{TARGET} ) + α \cdot {L}_{Beacon} + ( 1 - α ) \cdot {L}_{0} + C ( dBm ) \\ G ( n ) = G ( n - 1 ) + [ {b}_{TPC} \times {Δ}_{TPC} ] \\ {Δ}_{TPC} = \{ \begin{matrix}1 , \vert SINR - {SINR}_{Target} \vert < {TH}_{1} \\ 2 , {TH}_{1} \leq \vert SINR - {SINR}_{Target} \vert \leq {TH}_{2} \\ 3 , \vert SINR - {SINR}_{Target} \vert > {TH}_{2}\end{matrix}\end{matrix}$$
where P(dBm) denotes an uplink control power value, G(n) denotes a power control computation element of the current frame, G(n−1) denotes a power control element of the prior frame, I_{BTS} denotes cell interference power at the BTS, P(SINR_{TARGET}) denotes a power corresponding to a target- SINR, L_{Beacon} denotes current path loss acquired using a preamble and a pilot of a current downlink frame, L₀ denotes an average path loss observed for a long term, α is an arbitrary constant, C is a constant relating to a power of transmit data, SINR_{Target} denotes target-SINR, SINR denotes receive SINR value, and TH s denote preset thresholds.

19. The power control method of claim 17, wherein the I_{BTS} is received from the BTS in a broadcast channel periodically or at a specific time.

20. The power control method of claim 18, wherein the I_{BTS} is received from the BTS in a broadcast channel periodically or at a specific time.

21. The power control method of claim 13, wherein the power control method is applied to an OFDM or OFDMA communication system.

22. The power control method of claim 13, wherein the power control method is applied to an FDM or FDMA communication system.

23. A power control apparatus of a communication system, comprising:
a power determiner for determining a power value using a power control computation element of a current frame, which is acquired using a power control computation element of a prior frame and a power increase/decrease change estimated from a receiving link, and an interference.

24. A power control method of a communication system, comprising:
calculating a power control computation element of a current frame using a power control computation element of a prior frame and a power increase/decrease change estimated from a receiving link;
calculating a power value using an interference and the power control computation element of the current frame.
